(19) United States
(12) Patent Application Publication
(10) Pub. No.: US 2023/0174426 A1
(43) Pub. Date: Jun. 8, 2023

(54) BARITE FOR HEAVY METAL REMOVAL

(71) Applicant: Omya International AG, Oftringen (CH)

(72) Inventors: Tobias KELLER, Gränichen (CH); Manuel EGGIMANN, Bern (CH)

(73) Assignee: Omya International AG, Oftringen (CH)

(21) Appl. No.: 17/999,742

(22) PCT Filed: May 26, 2021
(86) PCT No.: PCT/EP2021/064125

§ 371 Date: Nov. 23, 2022

(30) Foreign Application Priority Data
May 27, 2020 (EP) 20176705.0

(51) Int. Cl. C04B 22/14; C04B 28/02; C04B 7/36; C02F 1/28; C02F 1/66

(52) U.S. Cl. CPC C04B 22/142; C04B 28/02; C04B 7/364; C02F 1/281; C02F 1/66; C04B 2103/0086

(57) ABSTRACT

The present invention relates to the use of particulate mineral material comprising barite for scavenging heavy metal anions from a liquid medium, wherein the heavy metal anions form water-insoluble barium salts with barium cations of the barite, and wherein the particulate mineral material has a specific surface area of from 0.1 m²/g to 100 m²/g, measured using nitrogen sorption and the BET method.

The present invention relates to the treatment of effluents containing heavy metals, and in particular to the use of a particulate mineral material comprising barite for scavenging heavy metal anions from a liquid medium, as well as a corresponding method for removing heavy metal anions from a liquid medium.

Many industries discharge large amounts of metal-contaminated effluents such as sludge, wastewater, or tailings bearing heavy metal cations such as Pb, Zn, Mn, Cd, Cu, Mo, Co, Hg, or Ni cations, or heavy metal anions such as chromate or arsenate. Because of their high solubility in aqueous mediums and since heavy metal ions are non-biodegradable, they can be absorbed by living organisms. Once they enter the food chain, large concentrations of heavy metals may accumulate in the human body. If the metals are ingested beyond the permitted concentration, they can cause serious health disorders. Serious health effects include reduced growth and development, cancer, organ damage, nervous system damage, and in extreme cases, death. Exposure to some metals, such as mercury and lead, may also cause development of autoimmunity, in which a person's immune system attacks its own cells. This can lead to joint diseases such as rheumatoid arthritis, and diseases of the kidneys, circulatory system, nervous system, and damaging of the fetal brain. At higher doses, heavy metals can cause irreversible brain damage. Another heavy metal, which deserves high attention is arsenic. Arsenic is a persistent contaminant in ground water with severe impact on human health when exposed to, amongst other sources, drinking water. Chromium is also a heavy metal of high environmental concern, primarily due to the toxicity and carcinogenicity of Cr(VI), and hence, stringent regulations apply for the presence of hexavalent chromium in drinking water and waste water.

Wastewater streams containing heavy metals are produced from different industries. For example, electroplating and metal surface treatment processes generate significant quantities of wastewaters containing heavy metals. Other sources for metal wastes include the wood processing industry, where arsenic-containing wastes are produced, and the petroleum refining which generates conversion catalysts contaminated with chromium. All of these and other industries produce a large quantity of wastewaters and sludges that requires extensive waste treatment.

Moreover, significant amounts of chromate are released by building materials such as concrete during processing or recycling of such materials. Chromate has a high solubility in water and thus during manipulation with wet concrete, construction workers may expose their hands facing a threat of skin irritation, allergic eczema or even more dangerous diseases. According to the REACH regulation of the European Union cement and cement-containing mixtures shall not be placed on the market, or used, if they contain, when hydrated, more than 2 mg/kg (0.0002%) soluble hexavalent chromium of the total dry weight of the cement.

Wastewater regulations were established to minimize human and environmental exposure to hazardous chemicals. This includes limits on the types and concentration of heavy metals that may be present in the discharged wastewater. Therefore, it is necessary to remove or minimize the heavy metal ions in wastewater systematically by treating metal-contaminated wastewater prior to its discharge to the environment.

Principally, several methods for the heavy metal removal from a metal-contaminated aqueous medium are known in the art. The conventional processes for removing heavy metals from wastewater include e.g. chemical precipitation, flotation, adsorption, ion exchange and electrochemical deposition. Ion exchange is another method being used in the industry for the removal of heavy metals from waste water or sludges. Electrolytic recovery or electro-winning is another technology used to remove metals from process water streams. This process uses electricity to pass a current through an aqueous metal-bearing solution containing a cathode plate and an insoluble anode. Positively charged metallic ions cling to the negatively charged cathodes leaving behind a metal deposit that is strippable and recoverable.

Over the last years and decades, environmental regulations have become more and more stringent, requiring an improved quality of treated effluent. Therefore, many of the known methods may no longer be efficient enough or are too costly due to the technique or the materials employed for the removal below the required level.

Although, many functionalized materials are known in the art, these materials are often designed for other purposes or are used in other fields. Exemplarily, reference is made to EP3192839 A1, which describes a process for the surface-treatment of a calcium carbonate-comprising material, which involves the adjustment of the pH-value of an aqueous suspension of at least one calcium carbonate-comprising material to a range from 7.5 to 12 and the addition of at least one surface-treatment agent to the aqueous suspension. Said surface-treatment agent is a silane compound as specified in EP3192839 A1.

Furthermore, the applicant would like to mention the patent application EP3599223 A1, relating to the use of a particulate mineral material being functionalized with one or more adsorption enhancing agents for scavenging and removing ionic metal contaminants from an aqueous medium, the patent application EP3599016 A1, relating to the use of a particulate material being functionalized with one or more scavenging agents for scavenging and removing cationic metal ions from an aqueous medium, and the unpublished patent application with filing number 19 193 114.6 in his name, relating to the use of a particulate mineral material comprising modified heulandite group zeolite.

In view of the foregoing, there is an ongoing need for the development of new efficient treatment technologies, which allow for the treatment of effluents containing heavy metals.

Accordingly, it is an object of the present invention to provide an agent that can be used in the treatment of effluents and/or process water containing heavy metals. It would be desirable to provide an agent that can be used in building materials such as cement. It would be also desirable that said agent provides a high removal performance for a broad range of heavy metal anions, and is especially effective in the removal of chromate. Furthermore, it would be desirable to use an agent, which is at least partially derivable from natural sources, is environmentally benign and inexpensive.

It is also an object of the present invention to provide an economic method for removing heavy metal anions from wastewater and/or building materials. It would be desirable to provide a method which requires no or only limited technical equipment for carrying out the same. It would also be desirable to provide a process which can remove heavy metals without altering the pH of the effluent.

The foregoing and other objects are solved by the subject-matter as defined in the independent claims.

According to one aspect of the present invention, use of particulate mineral material comprising barite for scavenging heavy metal anions from a liquid medium is provided, wherein the heavy metal anions form water-insoluble barium salts with barium cations of the barite and wherein the particulate mineral material has a specific surface area of from 0.1 m2/g to 100 m2/g, measured using nitrogen sorption and the BET method.

According to a further aspect of the present invention, a method for scavenging heavy metal anions from a liquid medium is provided, comprising the steps of:

a) providing particulate mineral material comprising barite, wherein the particulate mineral material has a specific surface area of from 0.1 m²/g to 100 m²/g, measured using nitrogen sorption and the BET method,

b) providing a liquid medium containing heavy metal anions, wherein the heavy metal anions form water-insoluble barium salts with barium cations of the barite, and

c) contacting the particulate mineral material of step a), and the liquid medium of step b) to scavenge heavy metal anions from the liquid medium by forming a heavy metal loaded particulate mineral material.

According to still a further aspect of the present invention, a method for scavenging heavy metal anions from a liquid medium is provided, comprising the steps of:

A) providing particulate mineral material comprising barite, wherein the particulate mineral material has a specific surface area of from 0.1 m²/g to 100 m²/g, measured using nitrogen sorption and the BET method,

B) providing a liquid medium,

C) providing a material composition that releases heavy metal anions on contact with said liquid medium, wherein the heavy metal anions form water-insoluble barium salts with barium cations of the barite, and

D) contacting the particulate mineral material of step A), the liquid medium of step B), and the material composition of step C) in any order to form a liquid medium containing said heavy metal anions and to scavenge said heavy metal anions from the liquid medium by forming a heavy metal loaded particulate mineral material.

According to still another aspect a building material composition comprising cement and a particulate mineral material comprising barite as scavenger for heavy metal anions is provided, wherein the heavy metal anions form water-insoluble barium salts with barium cations of the barite, and wherein the particulate mineral material has a specific surface area of from 0.1 m²/g to 100 m²/g, measured using nitrogen sorption and the BET method.

According to still another aspect of the present invention, use of particulate mineral material comprising barite as a scavenger for heavy metal anions in a building material composition comprising cement is provided, wherein the heavy metal anions form water-insoluble barium salts with barium cations of the barite, and wherein the particulate mineral material has a specific surface area of from 0.1 m2/g to 100 m2/g, measured using nitrogen sorption and the BET method.

Advantageous embodiments of the present invention are defined in the corresponding subclaims.

According to one embodiment the liquid medium is an aqueous medium, preferably the aqueous medium is selected from process water, sewage water, waste water, preferably waste water from the paper industry, waste water from the colour-, paints-, or coatings industry, waste water from breweries, waste water from the leather industry, agricultural waste water, slaughterhouse waste water, process or waste water from power plants, waste water from waste incineration, waste water from mercury recycling, waste water from cement production, waste water from concrete handling and production, waste water from shotcrete handling and production, waste water from steel production, waste water from production of fossil fuels, from sludge, preferably sewage sludge, harbour sludge, river sludge, coastal sludge, digested sludge, mining sludge, municipal sludge, civil engineering sludge, jet grouting sludge, sludge from oil drilling or the effluents the aforementioned dewatered sludges, or aqueous compositions comprising cement, preferably a cement paste or an aqueous building material comprising cement, or an aqueous system comprising hardened cement, preferably recycled concrete, or an aqueous system comprising wood ash.

According to one embodiment particulate mineral material comprises at least 60 wt.-% barite, based on the total weight of the particulate mineral material, preferably at least 80 wt.-%, more preferably at least 90 wt.-%, even more preferably at least 95 wt.-%, and most preferably the particulate mineral material consists of barite. According to a further embodiment the particulate mineral material has a volume median particle size d50 from 0.05 to 20 μm, preferably from 0.1 to 2 μm, more preferably from 0.2 to 0.8 μm, and most preferably from 0.3 to 0.5 μm, and/or a volume top cut particle size d98 from 0.15 to 200 μm, preferably from 0.5 to 50 μm, more preferably from 0.8 to 25 μm, and most preferably from 0.8 to 10 μm. According to still a further embodiment the particulate mineral material has a specific surface area of from 0.5 m2/g to 80 m2/g, preferably from 1 m2/g to 60 m2/g, more preferably from 3 m2/g to 50 m2/g, even more preferably from 4 m2/g to 35 m2/g, and most preferably from 10 m2/g to 30 m2/g, measured using nitrogen sorption and the BET method.

According to one embodiment the particulate mineral material is used in combination with a pH modifying agent, preferably selected from the group consisting of slaked lime, calcium carbonate, sodium hydroxide, potassium hydroxide, dolomite, half-burned dolomite, lime, brucite, magnesium oxide, and any combination thereof. According to a further embodiment the heavy metal anions are selected from the group consisting of chromate, arsenate, manganate, molybdate, selenate, ferrocyanide, and mixtures thereof. According to still a further embodiment the particulate mineral material comprising barite is used for scavenging and removing the heavy metal anions from the liquid medium.

According to one embodiment the particulate mineral material comprising barite is provided in a weight ratio of from 1:20000 to 1:30, preferably from 1:10000 to 1:35, more preferably from 1:1000 to 1:40 and most preferably from 1:850 to 1:45, relative to the weight of the heavy metal anions in the liquid medium. According to a further embodiment the method further comprises a subsequent step of removing the heavy metal loaded particulate mineral material from the liquid medium, preferably said step is performed by filtration, centrifugation, sedimentation, or flotation. According to still a further embodiment the building material composition is Portland cement, Pozzolan-lime cement, slag-lime cement, supersulfated cement, calcium sulfoaluminate cement, concrete, mortar, or hardened concrete.

It should be understood that for the purpose of the present invention, the following terms have the following meaning:

Unless specified otherwise, the term “drying” refers to a process according to which at least a portion of water is removed from a material to be dried such that a constant weight of the obtained “dried” material at 200° C. is reached. Moreover, a “dried” or “dry” material may be defined by its total moisture content which, unless specified otherwise, is less than or equal to 10.0 wt.-%, preferably less than or equal to 5 wt.-%, more preferably less than or equal to 2 wt.-%, and most preferably between 0.3 and 0.7 wt.-%, based on the total weight of the dried material.

The term “mineral material” in the meaning of the present invention refers to naturally occurring or synthetically produced substances that are solid under standard ambient temperature and pressure (SATP), i.e. at a temperature of 25° C. and an absolute pressure of 100 kPa. The naturally occurring substances are inorganic and have a crystal structure or are amorphous.

The term “particulate” in the meaning of the present document refers to materials composed of a plurality of particles. Said plurality of particles may be defined, for example, by its particle size distribution (d98, d50 etc.).

The “particle size” of particulate materials, for example, particulate mineral material comprising barite, is described as volume-based particle size distribution. Volume-based median particle size d50 was evaluated using a Malvern Mastersizer 3000 Laser Diffraction System equipped with an Aero S dry dispersing unit. The d50 or d98 value indicates a diameter value such that 50% or 98% by volume, respectively, of the particles have a diameter of less than this value. The raw data obtained by the measurement are analyzed using the Fraunhofer theory.

The terms “removal” or “removing” of heavy metal anions or “removal” of the heavy metal loaded particulate mineral material after scavenging the heavy metal anions refers to the process of separating the heavy metal loaded particulate mineral material (obtained from scavenging the heavy metal anions) from the liquid medium of the system, thereby separating the heavy metals in the solids completely or at least partially from the system.

“Scavenging” of heavy metal anions in the meaning of the present invention refers to the incorporation of the heavy metal anions present in the liquid phase into a solid phase, namely the particulate mineral material comprising barite. The term scavenging does not imply any underlying mechanism and covers any mechanism selected from “absorption”, “adsorption”, “ion-exchange”, and “precipitation” effects. These mechanisms are known to the skilled person.

The “specific surface area” (expressed in m2/g) of a material as used throughout the present document can be determined by the Brunauer Emmett Teller (BET) method with nitrogen as adsorbing gas and by use of a ASAP 2460 instrument from Micromeritics. The method is well known to the skilled person and defined in ISO 9277:2010. Samples are conditioned at 100° C. under vacuum for a period of 30 min prior to measurement. The total surface area (in m2) of said material can be obtained by multiplication of the specific surface area (in m2/g) and the mass (in g) of the material.

For the purpose of the present invention, the “solids content” of a liquid composition is a measure of the amount of material remaining after all the solvent or water has been evaporated. If necessary, the “solids content” of a suspension given in wt.-% in the meaning of the present invention can be determined using a Moisture Analyzer HR73 from Mettler-Toledo (T=120° C., automatic switch off 3, standard drying) with a sample size of 5 to 20 g.

A “solution” as referred to herein is understood to be a single phase mixture of a specific solvent and a specific solute, for example a single phase mixture of a water-soluble salt and water. The term “dissolved” as used herein thus refers to the physical state of a solute in a solution.

A “suspension” or “slurry” in the meaning of the present invention comprises undissolved solids and water, and optionally further additives, and usually contains large amounts of solids and, thus, is more viscous and can be of higher density than the liquid from which it is formed.

For the purpose of the present application, “water-insoluble” materials are defined as materials which, when 100 g of said material is mixed with 100 g deionised water and filtered on a filter having a 0.2 μm pore size at 20° C. to recover the liquid filtrate, provide less than or equal to 1 g of recovered solid material following evaporation at 95 to 100° C. of 100 g of said liquid filtrate at ambient pressure. “Water-soluble” materials are defined as materials which, when 100 g of said material is mixed with 100 g deionised water and filtered on a filter having a 0.2 μm pore size at 20° C. to recover the liquid filtrate, provide more than 1 g of recovered solid material following evaporation at 95 to 100° C. of 100 g of said liquid filtrate at ambient pressure.

Where an indefinite or definite article is used when referring to a singular noun, e.g., “a”, “an” or “the”, this includes a plural of that noun unless anything else is specifically stated.

Where the term “comprising” is used in the present description and claims, it does not exclude other elements. For the purposes of the present invention, the term “consisting of” is considered to be a preferred embodiment of the term “comprising”. If hereinafter a group is defined to comprise at least a certain number of embodiments, this is also to be understood to disclose a group, which preferably consists only of these embodiments.

Terms like “obtainable” or “definable” and “obtained” or “defined” are used interchangeably. This, for example, means that, unless the context clearly dictates otherwise, the term “obtained” does not mean to indicate that, for example, an embodiment must be obtained by, for example, the sequence of steps following the term “obtained” though such a limited understanding is always included by the terms “obtained” or “defined” as a preferred embodiment.

Whenever the terms “including” or “having” are used, these terms are meant to be equivalent to “comprising” as defined hereinabove.

According to the present invention, use of particulate mineral material comprising barite for scavenging heavy metal anions from a liquid medium is provided, wherein the heavy metal anions form water-insoluble barium salts with barium cations of the barite. The particulate mineral material has a specific surface area of from 0.1 m2/g to 100 m2/g, measured using nitrogen sorption and the BET method.

In the following details and preferred embodiments of the inventive use will be set out in more details. It is to be understood that these technical details and embodiments also apply to the inventive method and system.

### The Particulate Mineral Material

According to the present invention, a particular mineral material comprising barite is used for scavenging heavy metal anions from a liquid medium, wherein the heavy metal anions form water-insoluble barium salts with barium cations of the barite.

Barite is a mineral which has the composition BaSO4. Sometimes small amounts of barium may be replaced by strontium. The name barite is derived from the Greek word for “weight”, in allusion to its high density, which is about 4.5 g/cm3 (c.f. “barite”, Anthony et. al, Handbook of Mineralogy, Mineralogical Society of America, http://www.handbookofmineralogy.org). An alternative spelling is “baryte”. Other names that have been used for barite are “heavy spar” or “blanc fixe”. Barite crystallizes in an orthorhombic crystal system and develops mostly tabular to prismatic crystals, but also massive mineral aggregates, which in pure form are colorless or white in color, but can have many other colors due to impurities. Barite is chemically inert and almost insoluble in water. Barites occur most commonly as veins either singly or associated with chalcopyrite, galena, pyrite, sphalerite, quartz, fluorite, siderite, calcite, and dolomite, and also rarely with allanite, monazite, columbite, marcasite, magnetite, or tetrahedrite. It may also be found in other depositional environments such as sedimentary bedded deposits.

Barite can be mined from natural resources or can be produced synthetically by precipitation. Methods for producing precipitated barite are known in the art and are, for example, described in U.S. Pat. No. 1,040,594 A, US2003124048 A1, and JP2011184228 A. Barite is commercially available, for example, from Viaton Europe GmbH, Telligence Minerals Co., Ltd., or Steinbock Minerals Ltd.

In case barite is obtained from natural resources its precise composition, the number of its constituents and the amount of the single constituents may vary in a broad range usually depending on the source of origin, it may comprise additional minerals such as chalcopyrite, galena, pyrite, sphalerite, quartz, fluorite, siderite, calcite, dolomite, allanite, monazite, columbite, marcasite, magnetite, tetrahedrite, clay, iron minerals, heavy sulfide minerals, and mixtures thereof, as concomitant minerals in variable amounts.

The mined barite may be directly used after crushing, grinding, handsorting and/or selective screening. However, in certain cases barite may be beneficiated, for example, to remove objectionable impurities. Suitable beneficiation techniques are known to the skilled person and may comprise:
crushing followed by hand sorting and dry screening,
crushing followed by log washing or wet trammel screening,
heavy media drums and cone separation,
wet and/or dry jigging,
tabling and/or spiral concentration,
classification by cone and rake classifier and/or hydrocycloning,
dry and/or wet high intensity magnetic separation,
flotation, and/or
bleaching.

According to one embodiment, the barite is beneficiated by jigging and/or flotation.

According to one embodiment of the present invention, the barite is natural ground barite, precipitated barite, and mixtures thereof, preferably natural ground barite.

According to one embodiment the particulate mineral material comprises at least 60 wt.-% barite, based on the total weight of the particulate mineral material, preferably at least 80 wt.-%, more preferably at least 90 wt.-%, even more preferably at least 95 wt.-%, and most preferably the particulate mineral material consists of barite.

The particulate mineral material may be ground to obtain the desired particle size. The grinding may be carried out with any conventional grinding device, for example, under conditions such that refinement predominantly results from impacts with a secondary body, e.g. in one or more of: a ball mill, a rod mill, a vibrating mill, a sand mill, a roll crusher, a centrifugal impact mill, a vertical bead mill, an attrition mill, a pin mill, a hammer mill, a pulveriser, a shredder, a de-clumper, a knife cutter, or other such equipment known to the skilled man.

According to one embodiment the particulate mineral material has a volume median particle size d50 from 0.05 to 20 μm, preferably from 0.1 to 2 μm, more preferably from 0.2 to 0.8 μm, and most preferably from 0.3 to 0.5 μm. In addition or alternatively, the particulate mineral material has a volume top cut particle size d98 from 0.15 to 200 μm, preferably from 0.5 to 50 μm, more preferably from 0.8 to 25 μm, and most preferably from 0.8 to 10 μm.

The particulate mineral material has a specific surface area of from 0.1 m2/g to 100 m2/g, measured using nitrogen sorption and the BET method. According to one embodiment the particulate mineral material has a specific surface area of from 0.5 m2/g to 80 m2/g, preferably from 1 m2/g to 60 m2/g, more preferably from 3 m2/g to 50 m2/g, even more preferably from 4 m2/g to 35 m2/g, and most preferably from 10 m2/g to 30 m2/g, measured using nitrogen sorption and the BET method.

### Heavy Metal Anion Removal

According to one aspect of the present invention use of particulate mineral material comprising barite for scavenging heavy metal anions from a liquid medium is provided, wherein the heavy metal anions form water-insoluble barium salts with barium cations of the barite, and wherein the particulate mineral material has a specific surface area of from 0.1 m2/g to 100 m2/g, measured using nitrogen sorption and the BET method.

The liquid medium containing the heavy metal anions may be an organic medium or an aqueous medium.

According to one embodiment the liquid medium is an organic medium. The term “organic” medium refers to a liquid system, wherein the liquid phase consists of an organic solvent. For example, the organic medium may be an alcohol, an amide, an amine, an aromatic solvent, a ketone, an aldehyde, an ether, an ester, a carboxylic acid, a sulfoxide, an halogenated organic solvents, a nitro solvent, or a mixture thereof. According to one embodiment the organic medium is selected from methanol, ethanol, propanol, isopropanol, butanol, ethylene glycol, diethylene glycol, glycerol, dimethyl acetamide, dimethyl formamide, 2-pyrrolidone, piperidine, pyrrolidine, quinoline, benzene, benzyl alcohol, chlorobenzene, 1,2-dichlorobenzene, mesitylene, nitrobenzene, pyridine, tetralin, toluene, xylene, diisopropylether, diethylether, dibutylether, 1,4-dioxane, tetrahydrofuran, tetrahydropyran, morpholine, acetone, acetophenone, cyclopentanone, ethyl isopropyl ketone, 2-hexanone, pentanone, isopropyl acetate, formic acid, dimethyl sulfoxide, benzotrichloride, bromoform, carbon tetrachloride, chloroform, chloromethane, linear alkanes, branched alkanes, petroleum distillate fractions, crude oil, and mixtures thereof.

According to another embodiment of the present invention, the liquid medium is an aqueous medium. The term “aqueous” medium refers to a liquid system, wherein the liquid phase comprises, preferably consists of, water. However, said term does not exclude that the liquid phase of the aqueous medium comprises minor amounts of at least one water-miscible organic solvent. Examples of water-miscible organic solvents are methanol, ethanol, acetone, acetonitrile, tetrahydrofuran and mixtures thereof. If the aqueous medium comprises at least one water-miscible organic solvent, the liquid phase of the aqueous medium comprises the at least one water-miscible organic solvent in an amount of from 0.1 to 40.0 wt.-% preferably from 0.1 to 30.0 wt.-%, more preferably from 0.1 to 20.0 wt.-% and most preferably from 0.1 to 10.0 wt.-%, based on the total weight of the liquid phase of the aqueous medium. According to one embodiment, the liquid phase of the aqueous medium consists of water.

The aqueous medium may be process water, sewage water, waste water, sludge, or an effluent of dewatered sludge. Furthermore, the aqueous medium may be selected from aqueous compositions comprising cement, preferably a cement paste or an aqueous building material comprising cement, or an aqueous system comprising hardened cement, preferably recycled concrete, or an aqueous system comprising wood ash. According to one embodiment the aqueous medium is selected from process water, sewage water, waste water, preferably waste water from the paper industry, waste water from the colour-, paints-, or coatings industry, waste water from breweries, waste water from the leather industry, agricultural waste water, slaughterhouse waste water, process or waste water from power plants, waste water from waste incineration, waste water from mercury recycling, waste water from cement production, waste water from concrete handling and production, waste water from shotcrete handling and production, waste water from steel production, waste water from production of fossil fuels, from sludge, preferably sewage sludge, harbour sludge, river sludge, coastal sludge, digested sludge, mining sludge, municipal sludge, civil engineering sludge, jet grouting sludge, sludge from oil drilling or the effluents the aforementioned dewatered sludges, or aqueous compositions comprising cement, preferably a cement paste or an aqueous building material comprising cement, or an aqueous system comprising hardened cement, preferably recycled concrete, or an aqueous system comprising wood ash. According to one embodiment, the waste water from power plants is process or waste water from coal-fired power plants, preferably coal-fired power plants based on lignite.

Within the context of the present invention, the term “process water” refers to any water which is necessary to run or maintain an industrial process. The term “sewage water” refers to wastewater that is produced by a community of people, i.e. domestic wastewater or municipal wastewater. The term “waste water” refers to any water drained from its place of use, e.g. an industrial plant. The term “sludge” in the meaning of the present invention refers to any kind of sludge, e.g. primary sludge, biological sludge, mixed sludge, digested sludge, physico-chemical sludge and mineral sludge. In this regard, primary sludge comes from the settling process and usually comprises large and/or dense particles. Biological sludge comes from the biological treatment of wastewater and is usually made of a mixture of microorganisms. These microorganisms, mainly bacteria, amalgamate in bacterial flocs through the synthesis of exo-polymers. Mixed sludge is a blend of primary and biological sludges and usually comprises 35 wt.-% to 45 wt.-% of primary sludge and 65 wt.-% to 55 wt.-% of biological sludge. Digested sludge comes from a biological stabilizing step in the process called digestion and is usually performed on biological or mixed sludge. It can be done under different temperatures (mesophilic or thermophilic) and with or without the presence of oxygen (aerobic or anaerobic). Physico-chemical sludge is the result of a physico-chemical treatment of the wastewater and is composed of flocs produced by the chemical treatment. Mineral sludge is given to sludge produced during mineral processes such as quarries or mining beneficiation processes and essentially comprises mineral particles of various sizes.

A “cement” in the meaning of the present invention refers to a binder substance used for construction that sets, hardens, and adheres to other materials to bind them together. Cements used in construction are usually inorganic, often lime or calcium silicate based, and can be characterized as either hydraulic or non-hydraulic, depending on the ability of the cement to set in the presence of water. Non-hydraulic cement does not set in wet conditions or under water, but sets as it dries and reacts with carbon dioxide in the air. It is resistant to attack by chemicals after setting. Hydraulic cements (e.g., Portland cement) set and become adhesive due to a chemical reaction between the dry ingredients and water (cf. Wikipedia contributors, ‘Cement’, Wikipedia, The Free Encyclopedia, 23 Dec. 2019). According to one embodiment, the cement is a non-hydraulic cement, preferably Portland cement, Pozzolan-lime cement, slag-lime cement, supersulfated cement, calcium sulfoaluminate cement, and mixtures thereof. Cement is typically provided in form of a dry powder. Thus, an aqueous compositions comprising cement may be a slurry comprising finely dispersed cement. In addition, said aqueous composition may comprise further building materials such as mortar, sand, or gravel. According to one embodiment, the aqueous composition comprises cement and sand and/or gravel.

An aqueous system comprising hardened cement may comprise an aqueous medium and a solid cement-containing material. The cement-containing material may be in any suitable form, for example, in form of a block, pieces, fragments, pellets, granules, particles, or powder. According to one embodiment, the cement-containing material is concrete, mortar, stucco, or a mixture thereof.

“Wood ash” in the meaning of the present invention refers to the residue material left after the combustion of wood, e.g. after burning wood in a fireplace or an industrial power plant. Wood ash is typically provided in form of a powder. Thus, an aqueous system comprising wood ash may be a slurry comprising finely dispersed wood ash.

For the purpose of the present invention, the term “heavy metal” refers a metal or metalloid having a density of more than 4 g/cm3, preferably more than 4.5 g/cm3, and most preferably more than 5 g/cm3. According to the present invention those heavy metal anions are scavenged which form water-insoluble barium salts when brought into contact with barium cations released from the barite, i.e. the heavy metal anions are capable of forming water-insoluble barium salts with barium cations. Thus, the use of particulate mineral material comprising barite for scavenging heavy metal anions from a liquid medium is provided, wherein the heavy metal anions are capable of forming water-insoluble barium salts with barium cations released from the barite, and wherein the particulate mineral material has a specific surface area of from 0.1 m2/g to 100 m2/g, measured using nitrogen sorption and the BET method. In accordance with the definition of the term, “water-insoluble” provided above, a water-insoluble barium salt is a barium salt, which, when 100 g of said barium salt is mixed with 100 g deionised water and filtered on a filter having a 0.2 μm pore size at 20° C. to recover the liquid filtrate, provide less than or equal to 1 g of recovered barium salt following evaporation at 95 to 100° C. of 100 g of said liquid filtrate at ambient pressure.

According to one embodiment the heavy metal anions are selected from the group consisting of chromate, arsenate, manganate, molybdate, selenate, ferrocyanide, and mixtures thereof, preferably chromate and/or arsenate, and most preferably chromate. Water-insoluble barium salts of these heavy metal anions may comprise barium chromate, barium arsenate, barium manganate, barium molybdate, barium selenate, or barium ferrocyanide.

According to one embodiment of the present invention, use of particulate mineral material comprising barite for scavenging heavy metal anions from a liquid medium is provided, wherein the heavy metal anions are selected from the group consisting of chromate, arsenate, manganate, molybdate, selenate, ferrocyanide, and mixtures thereof, preferably chromate and/or arsenate, and most preferably chromate, and wherein the particulate mineral material has a specific surface area of from 0.1 m2/g to 100 m2/g, measured using nitrogen sorption and the BET method.

A method for scavenging heavy metal anions from a liquid medium may comprise the steps of:

I) providing particulate mineral material comprising barite, wherein the particulate mineral material has a specific surface area of from 0.1 m²/g to 100 m²/g, measured using nitrogen sorption and the BET method, wherein the particulate mineral material is provided separately and/or in combination with the material composition of step b) ii),

II) providing heavy metal anions, wherein the heavy metal anions form water-insoluble barium salts with barium cations of the barite, by
i) providing a liquid medium containing said heavy metal anions, or
ii) providing a liquid medium and a material composition that releases said heavy metal anions on contact with said liquid medium, thereby forming a liquid medium containing said heavy metal anions, and

III) contacting the particulate mineral material of step I) and the heavy metal anions of step II) to scavenge heavy metal anions from the liquid medium by forming a heavy metal loaded particulate mineral material.

The material composition may be any material which releases heavy metal anions on contact with a liquid medium, wherein a liquid medium containing said heavy metal anions is formed and wherein said heavy metal anions form water-insoluble barium salts with barium cations of the barite. According to one embodiment, the material composition comprises, preferably consists of, cement, hardened cement, wood ash, or mixtures thereof. According to another embodiment, the material composition is a building material composition comprising cement.

According to one embodiment, in step II) a liquid medium containing heavy metal anions is provided, wherein the heavy metal anions form water-insoluble barium salts with barium cations of the barite. Thus, a method for scavenging heavy metal anions from a liquid medium is provided, wherein the method comprises the steps of:

a) providing particulate mineral material comprising barite, wherein the particulate mineral material has a specific surface area of from 0.1 m²/g to 100 m²/g, measured using nitrogen sorption and the BET method,

b) providing a liquid medium containing heavy metal anions, wherein the heavy metal anions form water-insoluble barium salts with barium cations of the barite, and

c) contacting the particulate mineral material of step a) and the liquid medium of step b) to scavenge heavy metal ions from the liquid medium by forming a heavy metal loaded particulate mineral material.

According to another embodiment, in step II) a liquid medium and a material composition that releases heavy metal anions on contact with said liquid medium, thereby forming a liquid medium containing said heavy metal anions, are provided, wherein the heavy metal anions form water-insoluble barium salts with barium cations of the barite. In other words, the liquid medium and the material composition are provided separately and a liquid medium containing said heavy metal anions is obtained by contacting the liquid medium and the material composition. Thus, a method for scavenging heavy metal anions from a liquid medium is provided, wherein the method comprises the steps of:

a′) providing particulate mineral material comprising barite, wherein the particulate mineral material has a specific surface area of from 0.1 m²/g to 100 m²/g, measured using nitrogen sorption and the BET method,

b′) providing a liquid medium and a material composition that releases heavy metal anions on contact with said liquid medium, thereby forming a liquid medium containing said heavy metal anions, wherein the heavy metal anions form water-insoluble barium salts with barium cations of the barite, and

c′) contacting the particulate mineral material of step a′) and the liquid medium and the material composition of step b′) to scavenge heavy metal ions from the liquid medium by forming a heavy metal loaded particulate mineral material.

In general, the material composition that releases heavy metal anions on contact with a liquid medium, wherein the heavy metal anions form water-insoluble barium salts with barium cations of the barite, the particulate mineral material comprising barite, and the liquid medium can be brought into contact by any conventional means known to the skilled person and may be contacted in any order.

According to one embodiment, in step b′) a liquid medium and a material composition that releases said heavy metal anions on contact with said liquid medium are provided, and step c′) comprises the steps of contacting the material composition and the particulate mineral material in a first step, and subsequently, adding the liquid medium. According to a further embodiment, in step b′) a liquid medium and a material composition that releases said heavy metal anions on contact with said liquid medium are provided, and step c′) comprises the steps of contacting the material composition and the liquid medium in a first step, and subsequently, adding the particulate mineral material. According to still a further embodiment, in step b′) a liquid medium and a material composition that releases said heavy metal anions on contact with said liquid medium are provided, and step c′) comprises the steps of contacting the liquid medium and the particulate mineral material in a first step, and subsequently, adding the material composition.

According to a preferred embodiment, the particulate mineral material is provided in combination with the material composition of step II) ii). Thus, a method for scavenging heavy metal anions from a liquid medium is provided, wherein the method comprises the steps of:

A) providing particulate mineral material comprising barite, wherein the particulate mineral material has a specific surface area of from 0.1 m²/g to 100 m²/g, measured using nitrogen sorption and the BET method,

B) providing a liquid medium,

C) providing a material composition that releases heavy metal anions on contact with said liquid medium, wherein the heavy metal anions form water-insoluble barium salts with barium cations of the barite, and

D) contacting the particulate mineral material of step A), the liquid medium of step B), and the material composition of step C) in any order to form a liquid medium containing said heavy metal anions and to scavenge said heavy metal anions from the liquid medium by forming a heavy metal loaded particulate mineral material.

According to a preferred embodiment, in step D), the particulate mineral material of step A) is first mixed with the material composition of step C), and subsequently, said mixture is contacted with the liquid medium of step B).

In case a liquid medium containing said heavy metal anions is provided or formed by contacting the afore-mentioned material composition with a liquid medium, the contacting step may take place in that the surface of the liquid medium is at least partially covered with the particulate mineral material. Additionally or alternatively, the step of contacting may take place in that the liquid medium is mixed with the particulate mineral material. The skilled man will adapt the mixing conditions (such as the configuration of mixing speed) according to his needs and available equipment. According to a preferred embodiment the particulate mineral material is suspended in the liquid medium to be treated, e.g. by agitation means.

The contacting step may be carried out for a time period in the range of several seconds to several minutes, e.g. 20 s or more, preferably 30 s or more, more preferably 60 s or more, and most preferably for a period of 120 s or more. According to one embodiment the contacting step is carried out for at least 3 min, at least 4 min, at least 5 min, at least 10 min, at least 20 min, or at least 30 min.

The contacting may be carried out under stirring or mixing conditions. Any suitable mixer or stirrer known to the skilled person may be used. The mixing or stirring may be performed at a rotational speed of 5 rpm to 20000 rpm. In a preferred embodiment the mixing or stirring is performed at a rotational speed of 10 rpm to 1500 rpm, for example, at a rotational speed of 100 rpm, or 200 rpm, or 300 rpm, or 400 rpm, or 500 rpm, or 600 rpm, or 700 rpm, or 800 rpm, or 900 rpm, or 1000 rpm.

According to one embodiment the contacting step is carried out for a period in the range of 60 s to 180 s under mixing conditions at a rotational speed of 100 rpm to 1000 rpm. For example, the contacting is carried out for 120 s at a rotational speed of 300 rpm.

In general, the length and the rotational speed of contacting the liquid medium to be treated with the particulate mineral material is determined by the degree of heavy metal anion pollution and the specific liquid medium to be treated.

The contacting step can be carried out by providing the particulate mineral material comprising barite in a suitable amount. A suitable amount in this context is an amount, which is sufficiently high in order to achieve the desired grade of removal of heavy metal anions. It will be appreciated that such suitable amount will depend on the concentration of the heavy metal anions in the liquid medium as well as the amount of liquid medium to be treated.

According to one embodiment of the present invention the particulate mineral material comprising barite is provided in an amount from 0.01 to 3 wt.-%, based on the total weight of the liquid medium containing said heavy metal anions, preferably in an amount from 0.05 to 2 wt.-%, and more preferably in an amount from 0.1 to 1 wt.-%.

According to one embodiment the particulate mineral material comprising barite is provided in a weight ratio of from 1:20000 to 1:30, preferably from 1:10000 to 1:35, more preferably from 1:1000 to 1:40 and most preferably from 1:850 to 1:45, relative to the weight of the heavy metal anions in the liquid medium.

The particulate mineral material comprising barite can be provided as an aqueous suspension. Alternatively, it can be provided in any suitable solid form, e.g. in the form of a powder, granules, agglomerates, pellets or in form of a paste, moist particles, moist pieces, or moist cake.

According to one embodiment of the inventive methods, a liquid medium containing heavy metal anions is provided, wherein the heavy metal anions form water-insoluble barium salts with barium cations of the barite. The skilled person will appreciate that said liquid medium may also be obtained by contacting a liquid medium with a material composition that releases said heavy metal anions on contact with said liquid medium. In said case, it is also possible to provide an immobile phase, e.g. in the form of a cake or layer, comprising the particulate mineral material comprising barite, wherein the liquid medium to be treated runs through said immobile phase. According to another embodiment, the contacting step is carried out by passing the liquid medium through a bed and/or column of the particulate mineral material. For example, the contacting step is carried out by passing the liquid medium through a fixed bed installation, a packed column, a fluid bed contactor, or combinations thereof. Advantageously, for such installations the particulate mineral material comprising barite is processed into a technical body (such as a pellet, tablet, granule, or extrudate).

According to another embodiment, the liquid medium is passed through a permeable filter comprising the particulate mineral material comprising barite and being capable of retaining, via size exclusion, the particulate mineral material including the scavenged heavy metal cations, on the filter surface as the liquid is passed through by gravity and/or under vacuum and/or under pressure. This process is called “surface filtration”. In another preferred technique known as depth filtration, a filtering aid comprising a number of tortuous passages of varying diameter and configuration retains heavy metal cations by molecular and/or electrical forces absorbing the particulate mineral material including the scavenged heavy metal anions which is present within said passages, and/or by size exclusion, retaining the heavy metal anions scavenged by the particulate mineral material if it is too large to pass through the entire filter layer thickness. The techniques of depth filtration and surface filtration may additionally be combined by locating the depth filtration layer on the surface filter; this configuration presents the advantage that those particles that might otherwise block the surface filter pores are retained in the depth filtration layer.

The method of the present invention can be carried out in form of a batch process, a semi-continuous process, or a continuous process. Preferably, the method is carried out as a continuous process. According to one embodiment the particulate mineral material is dosed continuously into the liquid medium, wherein the particulate mineral material is in form of an aqueous suspension or in solid form, preferably in form of powder, granules, agglomerates, pellets or mixtures thereof. Alternatively, the liquid medium is passed continuously through an immobile phase, preferably a fixed bed installation, a packed column, a fluid bed contactor, or combinations thereof.

The inventors of the present invention surprisingly found that a particulate mineral material comprising barite can be effectively used to absorb a broad range of heavy metal anions from liquid media, wherein the heavy metal anions form water-insoluble barium salts with barium cations of the barite. In particular, it was found that the particulate mineral is highly effective in scavenging chromate, arsenate, manganate, molybdate, selenate, ferrocyanide, and mixtures thereof.

It is an advantage of the present invention that the heavy metal anions can be scavenged in one step without out the need of reduction steps. Furthermore, the particulate mineral material comprising barite is derivable from natural resources and can be produced in a fast, uncomplicated and cost-effective manner. Furthermore, the particular material can be easily removed from the liquid medium to be treated and is environmentally benign. Thus, it is possible to remove heavy metal anions from liquid media with no or very limited technical equipment.

According to one embodiment, a method for scavenging heavy metal anions from a liquid medium is provided comprising the steps of:

a) providing particulate mineral material comprising barite, wherein the particulate mineral material has a specific surface area of from 0.1 m²/g to 100 m²/g, measured using nitrogen sorption and the BET method

b) providing a liquid medium containing heavy metal anions, wherein said heavy metal anions are selected from the group consisting of chromate, arsenate, manganate, molybdate, selenate, ferrocyanide, and mixtures thereof, preferably chromate and/or arsenate, and most preferably chromate, and

c) contacting the particulate mineral material of step a), and the liquid medium of step b) to scavenge heavy metal anions from the liquid medium by forming a heavy metal loaded particulate mineral material.

According to another embodiment, a method for scavenging heavy metal anions from a liquid medium is provided comprising the steps of:

A) providing particulate mineral material comprising barite, wherein the particulate mineral material has a specific surface area of from 0.1 m²/g to 100 m²/g, measured using nitrogen sorption and the BET method,

B) providing a liquid medium,

C) providing a material composition that releases heavy metal anions on contact with said liquid medium, wherein said heavy metal anions are selected from the group consisting of chromate, arsenate, manganate, molybdate, selenate, ferrocyanide, and mixtures thereof, preferably chromate and/or arsenate, and most preferably chromate, and

D) contacting the particulate mineral material of step A), the liquid medium of step B), and the material composition of step C) in any order to form a liquid medium containing said heavy metal anions and to scavenge said heavy metal anions from the liquid medium by forming a heavy metal loaded particulate mineral material.

### Further Embodiments

According to one embodiment of the present invention, the particulate mineral material is used in combination with a pH modifying agent. A pH modifying agent may be added to keep the pH of the liquid medium at a constant level or within a specific range to avoid dissolution of barite, for example, the pH may be maintained between 4.5 and 9.5, preferably between 6.5 and 9.0, and more preferably between 7.0 and 8.5. Any pH modifying agent known to the skilled person may be used. According to one embodiment the pH modifying agent is selected from the group consisting of slaked lime, calcium carbonate, sodium hydroxide, potassium hydroxide, dolomite, half-burned dolomite, lime, brucite, magnesium oxide, and any combination thereof. According to a preferred embodiment, the pH modifying agent is calcium carbonate. According to one embodiment, the pH modifying agent has a volume median particle size d50 from 0.1 to 100 μm, preferably from 0.2 to 50 μm, more preferably from 0.5 to 30 μm, even more preferably from 0.8 to 20 μm, and most preferably from 1 to 10 μm.

According to one embodiment, a pH modifying agent is added before and/or during contacting step III) or c) or c′) or D), respectively, preferably the pH modifying agent is selected from the group consisting of slaked lime, calcium carbonate, sodium hydroxide, potassium hydroxide, dolomite, half-burned dolomite, lime, brucite, magnesium oxide, and any combination thereof. According to one exemplary embodiment, the pH modifying agent is added in combination with the particulate mineral material. According to another exemplary embodiment, the pH modifying agent is added in combination with the heavy metal anions, i.e. by mixing the liquid medium with the pH modifying agent.

According to one embodiment, during and/or after contacting step III) or c) or c′) or D), respectively, at least one flocculation aid selected from polymeric and/or non-polymeric flocculation aids is added. For example, the flocculation aid and the particulate mineral material are added simultaneously to the liquid medium containing the heavy metal anions. Alternatively, the flocculation aid and the particulate mineral material are added separately during the contacting step. For example, in case a liquid medium containing the heavy metal anions is provided, the liquid medium may be first contacted with the particulate mineral material and then with the flocculation aid, or in case a liquid medium and a material composition that releases said heavy metal anions on contact with said liquid medium are provided, the liquid medium may be first contacted with the material composition and the particulate mineral material, and then with the flocculating aid. The skilled person will adapt the treatment conditions and flocculation aid concentration according to his needs and available equipment.

According to one embodiment the flocculation aid is a polymeric flocculation aid. The polymeric flocculation aid can be non-ionic or ionic and preferably is a cationic or anionic polymeric flocculation aid. Any polymeric flocculation aid known in the art can be used in the process of the present invention. Examples of polymeric flocculation aids are disclosed in WO2013064492 A1. Alternatively, the polymeric flocculation aid may be a polymer as described as comb polymer in US20090270543 A1. In a preferred embodiment the polymeric flocculation aid is a cationic or anionic polymer selected from polyacrylamides, polyacrylates, poly(diallyldimethylammonium chloride), polyethyleneimines, polyamines or mixtures of these, and natural polymers such as starch, or natural modified polymers like modified carbohydrates. Preferably, the polymeric flocculation aid may have a weight average molecular weight of at least 100000 g/mol. In a preferred embodiment, the polymeric flocculation aid has a weight average molecular weight Mw in the range from 100000 to 10000000 g/mol, preferably in the range from 300000 to 5000000 g/mol, more preferably in the range from 300000 to 1000000 g/mol, and most preferably in the range from 300000 to 800000 g/mol.

According to another embodiment the flocculation aid is a non-polymeric flocculation aid. The non-polymeric flocculation aid may be a cationic flocculating agent comprising a salt of a fatty acid aminoalkyl alkanolamide of the following general structure:

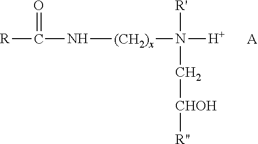

wherein R is a carbon chain of a fatty acid having from 14 to 22 carbon atoms, R′ is H, or C1 to C6 alkyl group, R″ is H, or CH₃, x is an integer of 1-6, and A is an anion. Examples of such non-polymeric flocculation aids are disclosed in U.S. Pat. No. 4,631,132 A.

According to a preferred embodiment of the present invention the flocculation aid is a non-polymeric flocculation aid selected from inorganic flocculation aids, for example selected from aluminium sulphate (Al2(SO4)3), or powder activated carbon (PAC). Such flocculation aids are known by the skilled person and are commercially available.

Optionally, further additives can be added to the liquid medium. These might include, for example, zeolites or phyllosilicates. The at least one phyllosilicate is preferably bentonite. Accordingly, the at least one phyllosilicate preferably comprises bentonite, more preferably consists of bentonite.

The scavenged heavy metal anions that have been immobilized in form of a heavy metal loaded particulate material may remain in the liquid medium or may be removed from the liquid medium. According to one embodiment, the particulate mineral material comprising barite is used for scavenging and removing heavy metal anions forming water-insoluble barium salts from a liquid medium.

The inventive methods may further comprise a subsequent step of removing the heavy metal loaded particulate mineral material from the liquid medium. According to one embodiment the method further comprises a step IV) or d) or d′) or E), respectively, of removing the heavy metal loaded particulate mineral material from the liquid medium after step III) or c) or c′) or D), respectively. Preferably the removing step may be performed by filtration, centrifugation, sedimentation, or flotation.

The heavy metal loaded particulate mineral material may be separated from the liquid medium by any conventional means of separation known to the skilled person. According to one embodiment of the present invention, in the removing step IV) or d) or d′) or E), respectively, the heavy metal loaded particulate mineral material is separated mechanically. Examples of mechanical separation processes are filtration, e.g. by means of a drum filter or filter press, nanofiltration, or centrifugation.

According to one embodiment the method further comprises a subsequent step of recycling the heavy metal loaded particulate mineral material, wherein the heavy metal loaded particulate mineral material is preferably recycled by a method comprising the step of treating the heavy metal loaded particulate mineral material with diluted sulphuric acid having, for example, a concentration of 0.1 M. Said step may be performed after the removing step IV) or d) or d′) or E), respectively.

According to a further aspect of the present invention, a system for removing heavy metal anions from a liquid medium comprising a reactor is provided, wherein the reactor comprises

particulate mineral material comprising barite, wherein the particulate mineral material has a specific surface area of from 0.1 m2/g to 100 m2/g, measured using nitrogen sorption and the BET method,

an inlet for a liquid medium containing heavy metal anions, wherein the heavy metal anions form water-insoluble barium salts with barium cations of the barite, and

an outlet for heavy metal ion depleted liquid medium,

preferably the reactor contains the particulate mineral material in form of pellets and/or the particulate mineral material is provided in form of a bed or column.

### Applications

The inventive use and the inventive method are not limited with respect to their application area. Suitable application areas are, for example, water purification, waste processing, recycling, remediation of contaminated soils or building material application.

It was surprisingly found by the inventors of the present invention that the particulate mineral material according to the present invention can be used to reduce the concentration of extractable heavy metal anions in cement-containing materials. In particular, chromium compounds are brought to cement by raw materials mixture, and may be leached after mixing the cement with water. The chromate present in the cement may penetrate the human skin and may cause chromium dermatitis. The inventors found that the particulate mineral material according to the present invention can scavenge heavy metal anions, which form water-insoluble barium salts with barium cations, within a building material composition. It is especially advantageous that the dry particulate mineral material can be pre-mixed with the dry building material composition, so that it is possible to provide dry building material composition, for example, ready-mix concrete, wherein said heavy metal anions are automatically scavenged when water is added to the dry building material composition. It was also found that the particulate mineral material according to the present invention neither affects the quality of the hardened building material composition nor has a corrosion-promoting effect.

According to a further aspect of the present invention, a building material composition comprising cement and a particulate mineral material comprising barite as scavenger for heavy metal anions is provided, wherein the heavy metal anions form water-insoluble barium salts with barium cations of the barite, and wherein the particulate mineral material has a specific surface area of from 0.1 m2/g to 100 m2/g, measured using nitrogen sorption and the BET method.

According to still a further aspect of the present invention, the use of barite as a scavenger for heavy metal anions in a building material composition comprising cement is provided, wherein the heavy metal anions form water-insoluble barium salts with barium cations of the barite, and wherein the particulate mineral material has a specific surface area of from 0.1 m2/g to 100 m2/g, measured using nitrogen sorption and the BET method.

The building material composition may be selected from any building material composition comprising cement known to the skilled person. According to one embodiment, the building material composition is Portland cement, Pozzolan-lime cement, slag-lime cement, supersulfated cement, calcium sulfoaluminate cement, concrete, mortar, or hardened concrete.

According to a preferred embodiment, a building material composition comprising cement and a particulate mineral material comprising barite as scavenger for arsenate and/or chromate, preferably chromate, is provided, wherein the particulate mineral material has a specific surface area of from 0.1 m2/g to 100 m2/g, measured using nitrogen sorption and the BET method. According to another preferred embodiment, the use of a particulate material comprising barite as a scavenger for arsenate and/or chromate, preferably chromate, in a building material composition comprising cement is provided, wherein the particulate mineral material has a specific surface area of from 0.1 m2/g to 100 m2/g, measured using nitrogen sorption and the BET method.

The scope and interest of the invention will be better understood based on the following examples which are intended to illustrate certain embodiments of the present invention and are non-limitative.

### EXAMPLES

### 1. Methods

### Specific Surface Area (BET)

The specific surface area (in m²/g) is determined using the BET method (using nitrogen as adsorbing gas), which is well known to the skilled man (ISO 9277:2010). The total surface area (in m²) of the filler material is then obtained by multiplication of the specific surface area and the mass (in g) of the corresponding sample.

### Particle Size

Volume median particle size d50 (vol) and volume top cut particle size d98 (vol) are evaluated using a Malvern Mastersizer 3000 Laser Diffraction System equipped with an Aero S dry dispersing unit. The d50 or d98 value, measured using a Malvern Mastersizer 3000 Laser Diffraction System, indicates a diameter value such that 50% or 98% by volume, respectively, of the particles have a diameter of less than this value. The raw data obtained by the measurement are analysed using the Fraunhofer theory.

The processes and instruments are known to the skilled person and are commonly used to determine the particle size of fillers and pigments.

### 2. Materials

TABLE 1
List of particular mineral materials and their physical characteristics.

| | | SSA(BET) | d₅₀ | d₉₈ |
|---|---|---|---|---|
| Mineral | Description | [m²/g] | [μm] | [μm] |
| B1 | Natural white barite, | 5.6 | 1.0 | 6.9 |
| | dry-ground on a jet mill | | | |
| B2 | Natural white barite, | 1.3 | 4.3 | 12 |
| | dry-ground on a pin mill (intermediate | | | |
| | fraction) | | | |
| B3 | Natural white barite, | 0.7 | 9.6 | 78 |
| | dry-ground on a pin mill (coarse | | | |
| | fraction) | | | |
| B4 | Natural barite, | 2.2 | 18 | 410 |
| | API grade, commercial product | | | |
| B5 | White natural barite, | 38.2 | n/a | n/a |
| | wet-milled in a ball mill and dried | | | |
| B6 | White natural barite, | 32.2 | n/a | n/a |
| | wet-milled in a ball mill and dried | | | |
| B7 | White natural barite, | 10.1 | n/a | n/a |
| | wet-milled in a ball mill and dried | | | |
| B8 | White natural barite, | 8.0 | n/a | n/a |
| | wet-milled in a ball mill and dried | | | |
| B9 | White natural barite, | 9.8 | n/a | n/a |
| | wet-milled in a (nano) ball mill and | | | |
| | dried | | | |
| B10 | White natural barite, | 12.4 | n/a | n/a |
| | wet-milled in a (nano) ball mill and | | | |
| | dried | | | |
| B11 | White natural barite, | 14.9 | n/a | n/a |
| | wet-milled in a (nano) ball mill and | | | |
| | dried | | | |
| B12 | Natural white barite, dry-ground on a | 0.6 | 22 | 320 |
| | pin mill | | | |
| B13 | Natural white barite, dry-ground on a | 0.8 | 10 | 115 |
| | pin mill | | | |
| B14 | Natural white barite, dry-ground on a | 1.4 | 3.8 | 11 |
| | pin mill | | | |
| B15 | Natural white barite, dry-ground on a | 3.1 | 1.4 | 5.4 |
| | pin mill | | | |
| B16 | Omyacarb ® 1-AV, | 3.7 | 2.2 | 10.2 |
| | commercial natural calcium carbonate | | | |

### 3. Examples

### Example 1—Chromate Scavenging Experiments with Calcium Carbonate as pH Modifier

A chromate (Cr(VI)) stock solution was prepared by dilution of a commercial 1000 ppm standard (TraceCERT®, 1000 mg/L Cr in nitric acid, prepared with (NH4)2Cr2O7, Sigma Aldrich, 68131-100ML-F) with Milli-Q filtered, deionized water to 1 ppm. For each experiment, 100-200 g of this stock solution was transferred into a glass flask and the barite-containing particulate mineral material and optionally calcium carbonate were added according to the indicated quantities. The solids were suspended by magnetic stirring with 25 mm stirring bars (800 rpm, 1 h). Subsequently, the suspensions filtered through a syringe filter (Chromafil Xtra, RC-20/25 0.2 μm). The content of Cr(VI) c(CrVI) was analysed using LCK 313 cuvette tests (EN ISO 11083) evaluated in a Hach Lange DR6000 spectral photometer.

TABLE 2
Removal experiments with
95 g of a 1 ppm Cr(VI) stock solution.

| | Mineral | m_{Mineral 1} | Mineral | m_{Mineral 2} | c(Cr_{VI}) | Removal |
|---|---|---|---|---|---|---|
| Test | 1 | [mg] | 2 | [mg] | [ppm] | [%] |
| C0 | — | — | — | — | 0.998 | — |
| (com- | | | | | | |
| parative) | | | | | | |
| C1 | B1 | 1000 | B16 | 100 | 0.03 | 97 |
| C2 | B1 | 500 | B16 | 100 | 0.052 | 95 |
| C3 | B1 | 250 | B16 | 100 | 0.099 | 90 |
| C4 | B1 | 500 | — | — | 0.042 | 96 |
| C5 | B2 | 500 | B16 | 100 | 0.268 | 73 |
| C6 | B3 | 500 | B16 | 100 | 0.622 | 38 |
| C7 | B4 | 500 | B16 | 100 | 0.696 | 30 |

From tests C1-C3, it is evident that the addition of a barite-containing particulate mineral material in combination with calcium carbonate leads to a reduced concentration of chromate in the solutions. The addition of larger quantities of barite leads to higher chromate removal. Test C4 demonstrates that a similar effect is attained also in the absence of calcium carbonate. Furthermore, tests C5-C7 demonstrate that the removal efficiency can be controlled by the particle size and the specific surface area.

### Example 2—Chromate Scavenging Under High pH Conditions

A chromate (Cr(VI)) stock solution was prepared by dilution of a commercial 10000 ppm standard (Sigma Aldrich) with Milli-Q filtered, deionized water to 10 ppm, 4 ppm, 2 ppm, and 0.5 ppm. 90 g of the stock solutions were transferred into a glass flask. Subsequently, 1 mL milk of lime (10 wt.-% Tagger Lime from Golling, Austria) was added to each glass flask to simulate the pH conditions in aqueous compositions comprising cement. Then, 0.5 g of the barite-containing mineral particulate mineral material was added. The solids were suspended by magnetic stirring (800 rpm, 1 h) and subsequently filtered through a syringe filter (Chromafil Xtra, RC-20/25 0.2 μm). The pH of the filtered solution were measured using a Mettler Toledo SevenMulti™ pH meter. The concentrations of Cr(IV) c(CrIV) in the filtered solutions was determined on a Hach Lange DR6000 spectral photometer using LCK 313 (Cr). Samples were diluted as necessary to match the target range of the cuvette tests.

TABLE 3
Experimental details and results of chromate removal experiments.

| Test | Mineral | mₘᵢₙₑᵣₐₗ [mg] | m_{Cr, solution} [g] | C_{Cr, start} [mg/L] | C_{Cr, end} [mg/L] | Cr_{removed} [%] | pH |
|---|---|---|---|---|---|---|---|
| C8 | B5 | 499.8 | 90.0 | 9.25 | 1.38 | 85.1 | 12.38 |
| C9 | B5 | 499.6 | 90.0 | 3.48 | 0.323 | 90.7 | 12.39 |
| C10 | B5 | 500.2 | 90.0 | 1.71 | 0.121 | 92.9 | 12.36 |
| C11 | B5 | 499.5 | 90.0 | 0.445 | 0.053 | 88.1 | 12.37 |
| C12 | B6 | 499.2 | 90.0 | 9.25 | 1.51 | 83.7 | 12.37 |
| C13 | B6 | 499.2 | 90.0 | 3.48 | 0.347 | 90.0 | 12.38 |
| C14 | B6 | 500.8 | 90.0 | 1.71 | 0.13 | 92.4 | 12.37 |
| C15 | B6 | 499.8 | 90.0 | 0.445 | 0.054 | 87.9 | 12.37 |
| C16 | B7 | 500.6 | 90.0 | 9.25 | 3.76 | 59.4 | 12.36 |
| C17 | B7 | 499.2 | 90.0 | 3.48 | 0.814 | 76.6 | 12.39 |
| C18 | B7 | 499.9 | 90.0 | 1.71 | 0.29 | 83.0 | 12.39 |
| C19 | B7 | 499.8 | 90.0 | 0.445 | 0.075 | 83.1 | 12.37 |
| C20 | B8 | 500.3 | 90.0 | 9.25 | 4.75 | 48.6 | 12.37 |
| C21 | B8 | 500.5 | 90.0 | 3.48 | 1.11 | 68.1 | 12.38 |
| C22 | B8 | 499.6 | 90.0 | 1.71 | 0.387 | 77.4 | 12.37 |
| C23 | B8 | 499.6 | 90.0 | 0.445 | 0.093 | 79.1 | 12.36 |
| C24 | B9 | 500.4 | 90.0 | 8.72 | 3.59 | 58.8 | 12.43 |
| C25 | B9 | 500.2 | 90.0 | 3.47 | 0.748 | 78.4 | 12.45 |
| C26 | B9 | 500.1 | 90.0 | 1.74 | 0.252 | 85.5 | 12.43 |
| C27 | B9 | 500.1 | 90.0 | 0.429 | 0.053 | 87.6 | 12.46 |
| C28 | B10 | 500.2 | 90.0 | 8.72 | 3.02 | 65.4 | 12.45 |
| C29 | B10 | 500.0 | 90.0 | 3.47 | 0.605 | 82.6 | 12.45 |
| C30 | B10 | 500.3 | 90.0 | 1.74 | 0.224 | 87.1 | 12.46 |
| C31 | B10 | 500.3 | 90.0 | 0.429 | 0.049 | 88.6 | 12.44 |
| C32 | B11 | 500.1 | 90.0 | 8.72 | 2.69 | 69.2 | 12.39 |
| C33 | B11 | 499.8 | 90.0 | 3.47 | 0.534 | 84.6 | 12.35 |
| C34 | B11 | 500.5 | 90.0 | 1.74 | 0.195 | 88.8 | 12.40 |
| C35 | B11 | 499.9 | 90.0 | 0.429 | 0.047 | 89.0 | 12.44 |

From tests C8-C35, it is evident that the addition of a barite-containing particulate mineral material at high pH conditions leads to a reduced concentration of chromate in the solutions. Furthermore, it can be gathered that with a given barite-containing particulate mineral material, the removal tends to be more efficient at higher chromate concentration. Furthermore, under otherwise identical conditions, barite-containing particulate mineral materials with higher surface areas tend to perform better than their counterparts with lower BET surfaces.

### Example 3—Chromate Removal from Cement Mixtures

4.5 g of cement (Cement CEM I 42.5N) was mixed with different barite quantities (2.25, 4.5, and 9 g), as indicated in Table 4 below. 6.75 g of Milli-Q water was added and mixed with a spatula during 30 sec. Then 13.5 g of sand (CEN-Normsand EN 196-1) was added to the mixture before mixing with a spatula for 1 min. The mixture was left for 10-20 min (as indicated), and then filtered through a Whatman Grade 42 filter paper using a Buchner funnel. The concentrations of Cr(IV) c(CrIV) in the filtrate was determined on a Hach Lange DR6000 spectral photometer using LCK 313 (Cr). Samples were diluted as necessary to match the target range of the cuvette tests.

TABLE 4
Experimental details and results of Example 3.

| Test | Mineral | mₘᵢₙₑᵣₐₗ [g] | C_{Cr, end} [mg/L] | Cr_{removed} [%] | Treatment time [min] |
|---|---|---|---|---|---|
| C36 (comparative) | — | — | 2.3 | 0 | 10 |
| C37 | B5 | 9 | 0.371 | 84 | 10 |
| C38 | B5 | 4.5 | 0.97 | 58 | 10 |
| C39 | B5 | 2.25 | 1.42 | 38 | 10 |
| C40 | B5 | 4.5 | 0.85 | 63 | 20 |
| C41 | B6 | 2.25 | 1.49 | 35 | 10 |
| C42 | B6 | 4.5 | 1.04 | 55 | 10 |
| C43 | B7 | 4.5 | 1.72 | 25 | 10 |
| C44 | B8 | 4.5 | 1.92 | 17 | 10 |

From test C36, it can be gathered that the concentration of chromate in the filtrate in absence of barite is 2.3 mg/L. Tests C37 to C39 illustrate that the addition of barite results in a reduced concentration of chromate in the filtrate. The utilization of a higher quantity of barite leads to a higher chromate removal. As illustrated by comparison of tests C38 and C40, the utilization of a longer contact time also improves the removal. Furthermore, tests C41 to C44 demonstrate that the removal efficiency can be controlled by the specific surface area.

### Example 4—Chromate Leaching from Hardened Cement

Concrete slabs were prepared from 1050 g of sand (CEN-Normsand EN 196-1), 380 g of cement (Cement CEM I 42.5N), 400 g of calcium carbonate (Betocarb HP OG), 190 g water, and 2.8 g of a polycarboxylate superplasticizer. In some of the samples, 200 g of the calcium carbonate was replaced by 200 g of different barite materials. After 7 days, the hardened slabs were transferred into ca. 1300 mL of demineralized water and extracted for 102 days. Subsequently, the concentration of Cr(IV) c(Criv) in the solutions was analyzed by ICP-MS.

TABLE 5
Experimental details and results of Example 4.

| Test | Mineral | mₘᵢₙₑᵣₐₗ [g] | C_{Cr, end} [μg/L] | Cr_{removed} [%] |
|---|---|---|---|---|
| C45 | — | — | 42 | — |
| (comparative) | | | | |
| C46 | B12 | 200 | 39 | 7 |
| C47 | B13 | 200 | 35 | 17 |
| C48 | B14 | 200 | 30 | 29 |
| C49 | B15 | 200 | 17 | 60 |

From test C45, it can be gathered that the concentration of chromate in the eluate in absence of barite is 42 μg/L. Tests C46 to C49 illustrate that the addition of barite results in a reduced concentration of chromate in the eluate. If materials with higher BET surface are utilized, the chromate removal is correspondingly improved.

### Example 5—Arsenate Scavenging Experiments

An As stock solution was prepared by dilution of a commercial standard solution (Arsenic Standard for ICP, TraceCERT®, 1000 mg/L As in nitric acid, Sigma Aldrich 01969-100ML-F) with Milli-Q filtered, deionized water to 4 ppm, 2 ppm and 0.5 ppm. 90 g of the stock solution was transferred into a glass flask. Then, 0.5 g of the barite-containing particulate mineral material was added. The solids were suspended by magnetic stirring (800 rpm, 1 h) and subsequently filtered through a syringe filter (Chromafil Xtra, RC-20/25 0.2 μm). The pH of the filtered solution were measured using a Mettler Toledo SevenMulti™ pH meter. The overall concentration of As in the samples were determined using ICP-MS a on NexION 350D instrument. Samples were diluted as necessary for the analysis.

TABLE 6
Experimental details and results of Example 5.

| Test | Mineral | mₘᵢₙₑᵣₐₗ [mg] | m_{As, solution} [g] | c_{As, start} [mg/L] | c_{As, end} [mg/L] | As_{removed} [%] | pH |
|---|---|---|---|---|---|---|---|
| A1 | B5 | 500.2 | 90.4 | 2.013 | 1.938 | 3.75 | 3.71 |
| A2 | B5 | 499.6 | 90.7 | 0.497 | 0.250 | 49.61 | 6.27 |
| A3 | B6 | 501.7 | 90.5 | 2.013 | 1.881 | 6.60 | 3.52 |
| A4 | B6 | 499.8 | 89.8 | 0.497 | 0.291 | 41.48 | 6.50 |
| A5 | B7 | 499.9 | 90.3 | 2.013 | 1.883 | 6.47 | 3.66 |
| A6 | B7 | 499.9 | 91.3 | 0.497 | 0.422 | 14.95 | 7.04 |
| A7 | B8 | 500.4 | 91.8 | 2.013 | 1.841 | 8.55 | 4.03 |
| A8 | B8 | 503.9 | 91.7 | 0.497 | 0.357 | 28.10 | 7.70 |

From tests A1 to A8, it is evident that the addition of a barite-containing particulate mineral material leads to a reduced As concentration in the solutions. Furthermore, it can be gathered that with a given barite-containing particulate mineral material, the removal tends to be more efficient at lower As concentration. Furthermore, under otherwise identical conditions, barite-containing particulate mineral materials with higher surface areas tend to perform better than their counterparts with lower BET surfaces.

1. A method of using a particulate mineral material comprising barite for scavenging heavy metal anions from a liquid medium comprising the steps of,
providing a particulate mineral material comprising barite and
providing a liquid medium,
wherein heavy metal anions form water-insoluble barium salts with barium cations of the barite, and wherein the particulate mineral material has a specific surface area of from 0.1 m²/g to 100 m²/g, measured using nitrogen sorption and the BET method.

2. The method according to claim 1, wherein the liquid medium is an aqueous medium, preferably the aqueous medium is selected from process water, sewage water, waste water, preferably waste water from the paper industry, waste water from the colour-, paints-, or coatings industry, waste water from breweries, waste water from the leather industry, agricultural waste water, slaughterhouse waste water, process or waste water from power plants, waste water from waste incineration, waste water from mercury recycling, waste water from cement production, waste water from concrete handling and production, waste water from shotcrete handling and production, waste water from steel production, waste water from production of fossil fuels, from sludge, preferably sewage sludge, harbour sludge, river sludge, coastal sludge, digested sludge, mining sludge, municipal sludge, civil engineering sludge, jet grouting sludge, sludge from oil drilling or the effluents the aforementioned dewatered sludges, or aqueous compositions comprising cement, preferably a cement paste or an aqueous building material comprising cement, or an aqueous system comprising hardened cement, preferably recycled concrete, or an aqueous system comprising wood ash.

3. The method according to claim 1, wherein the particulate mineral material comprises at least 60 wt.-% barite, based on the total weight of the particulate mineral material, preferably at least 80 wt.-%, more preferably at least 90 wt.-%, even more preferably at least 95 wt.-%, and most preferably the particulate mineral material consists of barite.

4. The method according to claim 1, wherein the particulate mineral material has a volume median particle size d₅₀ from 0.05 to 20 μm, preferably from 0.1 to 2 μm, more preferably from 0.2 to 0.8 μm, and most preferably from 0.3 to 0.5 μm, and/or a volume top cut particle size d₉₈ from 0.15 to 200 μm, preferably from 0.5 to 50 μm, more preferably from 0.8 to 25 μm, and most preferably from 0.8 to 10 μm.

5. The method according to claim 1, wherein the particulate mineral material has a specific surface area of from 0.5 m²/g to 80 m²/g, preferably from 1 m²/g to 60 m²/g, more preferably from 3 m²/g to 50 m²/g, even more preferably from 4 m²/g to 35 m²/g, and most preferably from 10 m²/g to 30 m²/g, measured using nitrogen sorption and the BET method.

6. The method according to claim 1, wherein the particulate mineral material is used in combination with a pH modifying agent, preferably selected from the group consisting of slaked lime, calcium carbonate, sodium hydroxide, potassium hydroxide, dolomite, half-burned dolomite, lime, brucite, magnesium oxide, and any combination thereof.

7. The method according to claim 1, wherein the heavy metal anions are selected from the group consisting of chromate, arsenate, manganate, molybdate, selenate, ferrocyanide, and mixtures thereof.

8. (canceled)

9. The method according to claim 1,
wherein the liquid medium contains the heavy metal anions, and comprising the further step of:
contacting the particulate mineral material and the liquid medium to scavenge heavy metal anions from the liquid medium by forming a heavy metal loaded particulate mineral material.

10. A method according to claim 1 comprising the further steps of:
providing a material composition that releases heavy metal anions on contact with said liquid medium, wherein the heavy metal anions form water-insoluble barium salts with barium cations of the barite, and
contacting the particulate mineral material, the liquid medium, and the material composition in any order to form a liquid medium containing said heavy metal anions and to scavenge said heavy metal anions from the liquid medium by forming a heavy metal loaded particulate mineral material.

11. The method of claim 9, wherein the particulate mineral material comprising barite is provided in a weight ratio of from 1:20000 to 1:30, preferably from 1:10000 to 1:35, more preferably from 1:1000 to 1:40 and most preferably from 1:850 to 1:45, relative to the weight of the heavy metal anions in the liquid medium.

12. The method of claim 9, wherein the method further comprises a subsequent step of removing the heavy metal loaded particulate mineral material from the liquid medium, preferably said step is performed by filtration, centrifugation, sedimentation, or flotation.

13. A building material composition comprising cement and a particulate mineral material comprising barite as scavenger for heavy metal anions, wherein the heavy metal anions form water-insoluble barium salts with barium cations of the barite, and wherein the particulate mineral material has a specific surface area of from 0.1 m²/g to 100 m²/g, measured using nitrogen sorption and the BET method.

14. The building material composition of claim 13, wherein the building material composition is Portland cement, Pozzolan-lime cement, slag-lime cement, supersulfated cement, calcium sulfoaluminate cement, concrete, mortar, or hardened concrete.

15. A method of using a particulate mineral material comprising barite as a scavenger for heavy metal anions in a building material composition comprising cement comprising the steps of,
mixing the particulate mineral material with a dry building material to form the building material composition; and
adding a liquid medium to the building material composition;
wherein the heavy metal anions form water-insoluble barium salts with barium cations of the barite, and wherein the particulate mineral material has a specific surface area of from 0.1 m²/g to 100 m²/g, measured using nitrogen sorption and the BET method.

16. The method of claim 10, wherein the particulate mineral material comprising barite is provided in a weight ratio of from 1:20000 to 1:30, preferably from 1:10000 to 1:35, more preferably from 1:1000 to 1:40 and most preferably from 1:850 to 1:45, relative to the weight of the heavy metal anions in the liquid medium.

17. The method of claim 10, wherein the method further comprises a subsequent step of removing the heavy metal loaded particulate mineral material from the liquid medium, preferably said step is performed by filtration, centrifugation, sedimentation, or flotation.

18. The composition of claim 13, wherein the particulate mineral material comprises at least 60 wt.-% barite, based on the total weight of the particulate mineral material, preferably at least 80 wt.-%, more preferably at least 90 wt.-%, even more preferably at least 95 wt.-%, and most preferably the particulate mineral material consists of barite.

19. The composition of claim 13, wherein the particulate mineral material has a volume median particle size d₅₀ from 0.05 to 20 μm, preferably from 0.1 to 2 μm, more preferably from 0.2 to 0.8 μm, and most preferably from 0.3 to 0.5 μm, and/or a volume top cut particle size d₉₈ from 0.15 to 200 μm, preferably from 0.5 to 50 μm, more preferably from 0.8 to 25 μm, and most preferably from 0.8 to 10 μm.

20. The composition of claim 13, wherein the particulate mineral material has a specific surface area of from 0.5 m²/g to 80 m²/g, preferably from 1 m²/g to 60 m²/g, more preferably from 3 m²/g to 50 m²/g, even more preferably from 4 m²/g to 35 m²/g, and most preferably from 10 m²/g to 30 m²/g, measured using nitrogen sorption and the BET method.

21. The composition of claim 13, wherein the heavy metal anions are selected from the group consisting of chromate, arsenate, manganate, molybdate, selenate, ferrocyanide, and mixtures thereof.
